(19) United States
(12) Patent Application Publication
(10) Pub. No.: US 2024/0364194 A1
(43) Pub. Date: Oct. 31, 2024

(54) METHOD FOR MANUFACTURING ROTOR

(71) Applicant: TOYOTA BOSHOKU KABUSHIKI KAISHA, Aichi-ken (JP)

(72) Inventors: Makoto KITAHARA, Toyota-shi (JP); Masaki SUGIYAMA, Okazaki-shi (JP)

(73) Assignee: TOYOTA BOSHOKU KABUSHIKI KAISHA, Aichi-ken (JP)

(21) Appl. No.: 18/641,906

(22) Filed: Apr. 22, 2024

(30) Foreign Application Priority Data
Apr. 25, 2023 (JP) 2023-071633

(51) Int. Cl. H02K 15/03; B29C 45/00; B29C 45/14; B29C 45/73; B29K 705/12; B29L 31/00; H02K 1/276

(52) U.S. Cl. CPC H02K 15/03; B29C 45/0055; B29C 45/14639; B29C 45/73; B29C 45/14065; B29C 2045/14122; B29C 2045/7356; B29K 2705/12; B29L 2031/7498; H02K 1/276

(57) ABSTRACT

A method for manufacturing a rotor includes clamping a first die and a second die so as to hold a core between the first die and the second die in a state in which a magnet is accommodated in a magnet housing hole of the core, injecting thermoplastic into the magnet housing hole, and opening the first die and the second die and removing the core and the magnet from a space between the first die and the second die. The removing the core and the magnet includes removing the core and the magnet from the space between the first die and the second die when a temperature of the thermoplastic injected into the magnet housing hole is higher than or equal to a glass transition point and lower than a melting point.

### BACKGROUND

### 1. Field

The present disclosure relates to a method for manufacturing a rotor.

### 2. Description of Related Art

Japanese Laid-Open Patent Publication No. 2015-6088 discloses a magnet-embedded rotor that is used as a rotor for a rotating electric machine. The rotor disclosed in the publication includes a core having magnet housing holes and magnets accommodated in the magnet housing holes. The magnets are fixed to the core with plastic filling the magnet housing holes. A thermoplastic is used as the plastic for filling the magnet housing holes.

The rotor disclosed in the above publication is manufactured by using a die apparatus as follows.

First, the die apparatus performs die clamping, so that a core having magnets accommodated in magnet housing holes is set inside the die apparatus. Subsequently, molten plastic is injected into the magnet housing holes through a passage of the die apparatus. Thereafter, the plastic filling the magnet housing holes is cooled for a specified amount of time to harden the plastic. At the point in time when the plastic filling the magnet housing holes is sufficiently hardened, the die apparatus is opened and the rotor is taken out from the inside of the die apparatus.

The viscosity of a thermoplastic increases as its temperature is lowered. Thus, when manufacturing a rotor using such a thermoplastic with a die apparatus, there is a risk of reducing yield due to the thermoplastic not filling the magnet housing holes effectively if the temperature of the injected plastic is relatively low.

By raising the temperature of the plastic to be injected to a level at which the viscosity of the plastic is maintained low, it becomes possible to properly perform the injection and filling of the plastic into the magnet housing holes. However, an increase in the temperature of the injected plastic extends the cycle time for injection molding. In other words, if the temperature of the plastic to be injected is set to be high, the time required to cool the plastic filling the magnet housing holes will be extended correspondingly, resulting in a longer cycle time for the injection molding. This may reduce the productivity of the rotor manufacturing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a rotor is provided. The rotor includes a core that includes a magnet housing hole and a magnet that is accommodated in the magnet housing hole and fixed to the core with a thermoplastic. The core has a first end face and a second end face, which is located on a side opposite to the first end face. The magnet housing hole opens in the first end face and the second end face. The method includes: clamping a first die and a second die so as to hold the core between the first die and the second die in a state in which the magnet is accommodated in the magnet housing hole; injecting the thermoplastic into the magnet housing hole after the die clamping; and after injecting the thermoplastic, opening the first die and the second die and removing the core and the magnet from a space between the first die and the second die. The removing the core and the magnet includes removing the core and the magnet from the space between the first die and the second die when a temperature of the thermoplastic injected into the magnet housing hole is higher than or equal to a glass transition point and lower than a melting point.

Other features and aspects will be apparent from the following detailed description, the drawings, and the claims.

### BRIEF DESCRIPTION OF THE DRAWINGS

FIG. 1 is a perspective view of a rotor that is manufactured through a manufacturing method according to one embodiment.

FIG. 2 is a cross-sectional view of the rotor shown in FIG. 1.

FIG. 3 is a cross-sectional view illustrating an apparatus for manufacturing the rotor shown in FIG. 1.

FIG. 4 is a cross-sectional view illustrating a state in which a tab is crushed.

FIG. 5 is a cross-sectional view illustrating a state in which a core is placed on a first die.

FIG. 6 is a cross-sectional view illustrating a state in which the core is pressed by a second die.

FIG. 7A is a cross-sectional view illustrating the core before die clamping.

FIG. 7B is a cross-sectional view illustrating the core in a die clamping state.

FIG. 8 is a cross-sectional view illustrating a state in which plastic is injected into magnet housing holes.

FIG. 9 is an explanatory diagram of a correction step.

FIG. 10 is a perspective view of a correction jig.

FIG. 11 is a cross-sectional view of a support plate according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

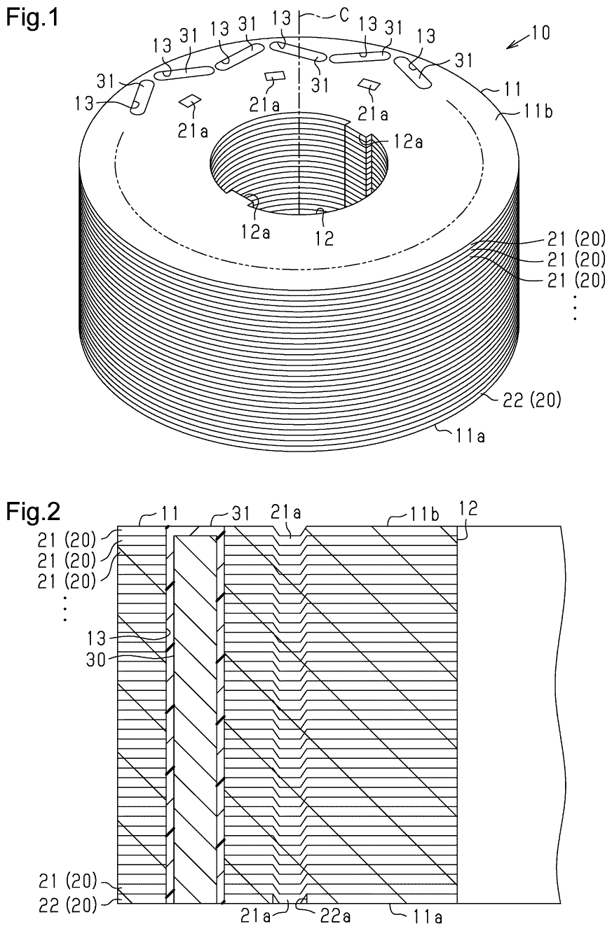

A method for manufacturing a rotor according to one embodiment will now be described with reference to FIGS. 1 to 10.

### Rotor 10

As shown in FIGS. 1 and 2, a rotor 10 includes a core 11, magnets 30, and plastic 31. The rotor 10 is, for example, a magnet-embedded rotor.

The core 11 is substantially shaped as a cylinder having an axis C as the central axis. The core 11 is formed, for example, by stacking iron core pieces 20 that are punched out from a magnetic steel sheet. In the following description, the direction in which the iron core pieces 20 are stacked will simply be referred to as a stacking direction.

The core 11 includes a first end face 11a and a second end face 11b, which are located on opposite sides in the stacking direction. The core 11 includes a center hole 12, into which a shaft (not shown) is inserted, and magnet housing holes 13, in which magnets 30 are accommodated. The center hole 12 and the magnet housing holes 13 extend through the core 11 in the stacking direction. That is, the center hole 12 and the magnet housing holes 13 open both in the first end face 11a and the second end face 11b of the core 11.

The center hole 12 has a substantially circular cross section. Two keys 12a are provided on the inner surface of the center hole 12. The two keys 12a are positioned on opposing locations within the inner surface of the center hole 12, with the axis C in between. Each key 12a is a protrusion extending parallel to the axis C. In the present embodiment, the two keys 12a are fitted into two keyways (not shown) provided in the shaft to restrict relative movement between the core 11 and the shaft in the circumferential direction.

The iron core pieces 20 include first iron core pieces 21 and a second iron core piece 22. The core 11 is formed by, for example, stacking multiple first iron core pieces 21 and one second iron core piece 22. The second iron core piece 22 forms one end face in the stacking direction of the core 11 (the lower surface as viewed in FIG. 2). The second iron core piece 22 forms, for example, the first end face 11a of the core 11.

Each first iron core piece 21 includes tabs 21a that bulge toward one side in the stacking direction. The tabs 21a are arranged at equal intervals in the circumferential direction of each first iron core piece 21. The first iron core pieces 21 adjacent to each other are coupled together by press-fitting the tabs 21a in the first iron core pieces 21 to each other.

The second iron core piece 22 includes through-holes 22a extending through the second iron core piece 22 in the stacking direction. The through-holes 22a are arranged at equal intervals in the circumferential direction of the second iron core piece 22.

The first iron core piece 21 and the second iron core piece 22 are coupled to each other by inserting the tabs 21a into the through-holes 22a.

The magnets 30 are accommodated in the magnet housing holes 13. Specifically, each magnet 30 is accommodated in different one of the magnet housing holes 13. The magnets 30 have an elongated shape extending in the stacking direction. The magnets 30 have a substantially rectangular cross-sectional shape orthogonal to the stacking direction.

The core 11 has a stacking height, which is the dimension from the first end face 11a to the second end face 11b. The length of each magnet 30 in the stacking direction is less than the stacking height of the core 11. Each magnet 30 includes a first end face and a second end face, which face in opposite directions from each other in the stacking direction. The first end face (the lower surface as viewed in FIG. 2) of each magnet 30 is, for example, flush with the first end face 11a of the core 11. The second end face (the upper surface as viewed in FIG. 2) of each magnet 30 is located inward (on the lower side as viewed in FIG. 2) of the second end face 11b of the core 11 in the stacking direction.

The magnets 30 are fixed to the core 11 with the plastic 31 filling the magnet housing holes 13. The plastic 31 is located between the outer peripheral surface of each magnet 30 and the inner circumferential surface of the corresponding magnet housing hole 13. The plastic 31 covers the second end face of the magnet 30. The plastic 31 is, for example, a thermoplastic such as a liquid-crystal polymer.

### Manufacturing Apparatus 40

A manufacturing apparatus 40 for manufacturing the rotor 10 will now be described.

The manufacturing apparatus 40 is configured to mold the plastic 31 by injecting thermoplastic material into the magnet housing holes 13 of the core 11, in which the magnets 30 are accommodated, thereby filling the magnet housing holes 13 with the thermoplastic material.

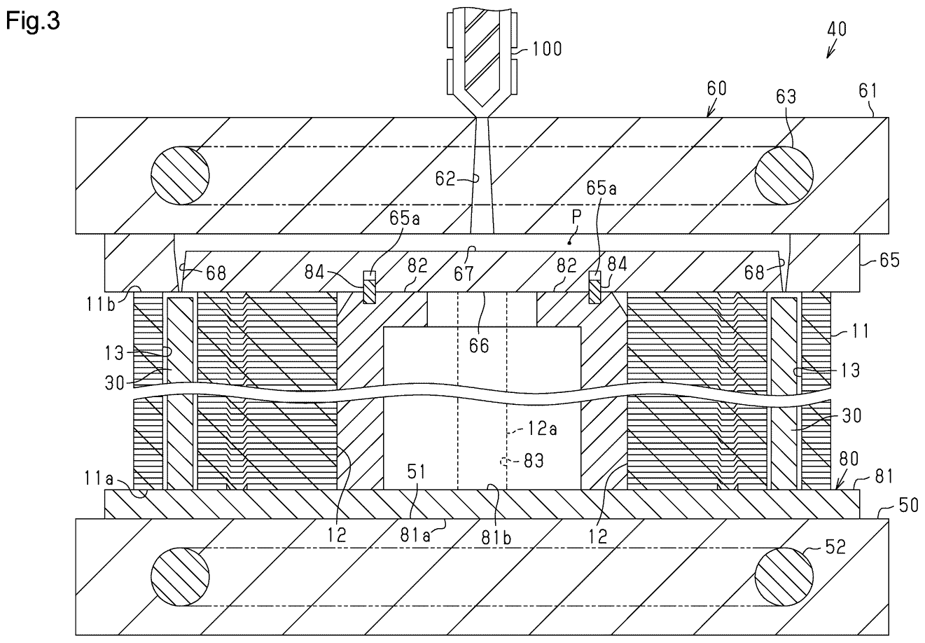

As shown in FIG. 3, the manufacturing apparatus 40 includes a first die 50 and a second die 60.

### First Die 50

The first die 50 is, for example, a fixed die of a die apparatus. The first die 50 includes a first contacting surface 51, which faces the first end face 11a of the core 11. The first contacting surface 51 is flat. The first contacting surface 51 has a size that covers the openings of all the magnet housing holes 13 that open in the first end face 11a. The first die 50 incorporates, for example, a first heater 52, which generates heat when energized.

### Second Die 60

The second die 60 includes a die body 61 and a gate plate 65. The die body 61 is, for example, formed separately from the gate plate 65. The die body 61 is, for example, a movable die of the die apparatus. The die body 61 is configured to approach and move away from the first die 50. The die body 61 includes a sprue 62, through which the plastic 31 injected from an injection device 100 flows through. The die body 61 incorporates, for example, a second heater 63, which generates heat when energized.

### Gate Plate 65

The gate plate 65 is disposed between the die body 61 and the core 11. The gate plate 65 includes a second contacting surface 66, which contacts the second end face 11b of the core 11. The second contacting surface 66 is flat. The second contacting surface 66 has a size that covers the openings of all the magnet housing holes 13 that open in the second end face 11b.

The gate plate 65 includes multiple runners 67, which are connected to the sprue 62, and multiple gates 68, which respectively extend from the runners 67. The runners 67 open in a surface of the gate plate 65 on a side opposite to the second contacting surface 66. The runners 67 extend radially from a central portion of the gate plate 65. Each gate 68 opens in the second contacting surface 66. Each gate 68 corresponds to one of the magnet housing holes 13. Each gate 68 connects the end of the runner 67 to the corresponding magnet housing hole 13.

The gate plate 65 includes multiple fitting holes 65a. The fitting holes 65a opens in the second contacting surface 66 of the gate plate 65 and extend in the thickness direction of the gate plate 65 (vertical direction as viewed in FIG. 3). The fitting holes 65a are arranged at equal intervals about the central portion of the gate plate 65.

### Support Member 80

The support member 80 is used to manufacture the rotor 10. The support member 80 supports the core 11 and the magnets 30. The support member 80 includes a substantially rectangular support plate 81 and a cylindrical post portion 82 protruding from a center portion in plan view of the support plate 81. The post portion 82 extends in the thickness direction of the support plate 81 (the vertical direction as viewed in FIG. 3). When the core 11 is attached to the support member 80, the post portion 82 of the support member 80 is inserted into the center hole 12 of the core 11.

The post portion 82 includes two engagement grooves 83 in the outer circumferential surface. Each engagement groove 83 extends in the axial direction of the post portion 82. The engagement grooves 83 each have a shape that corresponds to the keys 12a of the core 11. When the core 11 is attached to the support member 80, the keys 12a of the core 11 are fitted to the engagement grooves 83 of the support member 80 to determine the position of the core 11 relative to the support member 80.

When manufacturing the rotor 10, the support member 80 is placed on the first die 50, while supporting the core 11 and the magnets 30. At this time, the support plate 81 of the support member 80 is held between the first die 50 and the core 11. Specifically, a first end face 81a in the thickness direction of the support plate 81 is brought into contact with the first end face 11a of the core 11. The first end face 81a has a size that covers the openings of all the magnet housing holes 13, which open in the first end face 11a of the core 11. A second end face 81b in the thickness direction of the support plate 81 is brought into contact with the first contacting surface 51 of the first die 50.

The post portion 82 includes fitting pins 84 at the distal end (upper end as viewed in FIG. 3). The fitting pins 84 are provided at equal intervals in the circumferential direction of the post portion 82 and correspond to the fitting holes 65a. The fitting pins 84 are cylindrical and projects from the distal end of the post portion 82. When the rotor 10 is manufactured, the gate plate 65 is placed on the second end face 11b of the core 11. At this time, the fitting pins 84 of the post portion 82 are fitted to the corresponding fitting holes 65a of the gate plate 65 so that the position of the gate plate 65 is determined with respective to the support member 80 and the core 11.

### Method for Manufacturing Rotor 10

The method for manufacturing the rotor 10 includes a crushing step, a first arranging step, a second arranging step, a die clamping step, a heating step, an injection step, a cooling step, a removal step, a correction step, and a hardening step. The crushing step, the first arranging step, the second arranging step, the die clamping step, the heating step, the injection step, the cooling step, the removal step, the correction step, and the hardening step are performed in that order.

### Crushing Step

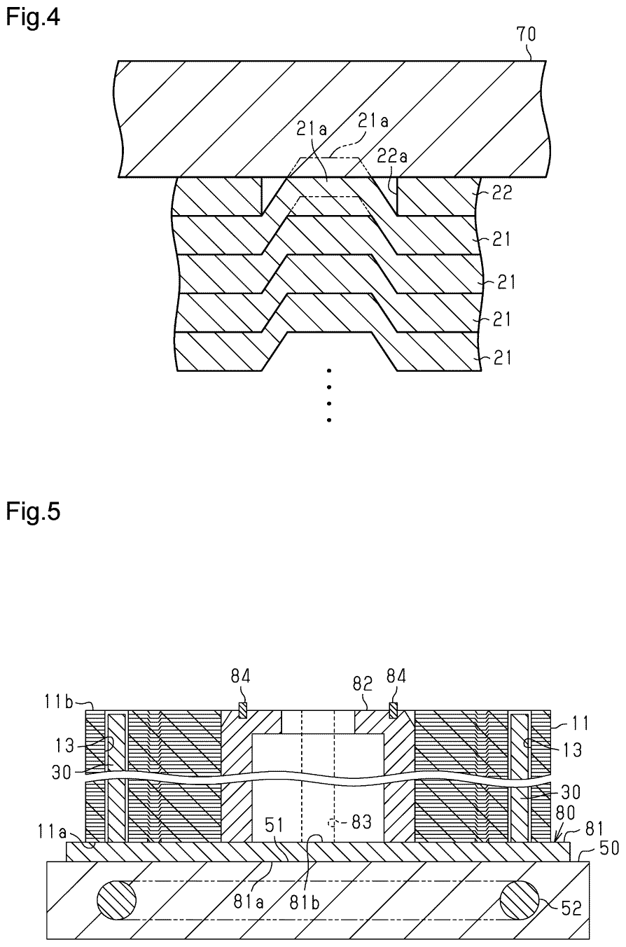

As indicated by the long-dash double-short-dash lines in FIG. 4, when the first iron core pieces 21 and the second iron core piece 22 are joined together through press-fitting, the protruding ends of the tabs 21a of the first iron core piece 21 adjacent to the second iron core piece 22 may protrude outward from the through-holes 22a of the second iron core piece 22.

In the crushing step, a pressing jig 70 presses the protruding ends of the tabs 21a, which protrude from the through-holes 22a of the second iron core pieces 22, so that the tabs 21a are crushed. In the crushing step, the tabs 21a are crushed such that the protruding end of each tab 21a is located inside the through-hole 22a, that is, such that the tab 21a does not protrude beyond the first end face 11a of the core 11.

### First Arranging Step

In the first arranging step, the support member 80, which supports the core 11 and the magnets 30, is placed on the first contacting surface 51 of the first die 50 as shown in FIG. 5.

Each housing hole 13 of the core 11 accommodates a magnet 30. The first end face 11a of the core 11 faces the first contacting surface 51 of the first die 50. The first end face 81a of the support plate 81 entirely covers the first end face 11a of the core 11. That is, the first end face 81a of the support plate 81 closes the openings of all the magnet housing holes 13 that open in the first end face 11a. The lower surface of each magnet 30 contacts the first end face 81a of the support plate 81. The upper surface of each magnet 30 is located below the second end face 11b of the core 11. The support plate 81 is held between the first die 50 and the first end face 11a of the core 11.

### Second Arranging Step

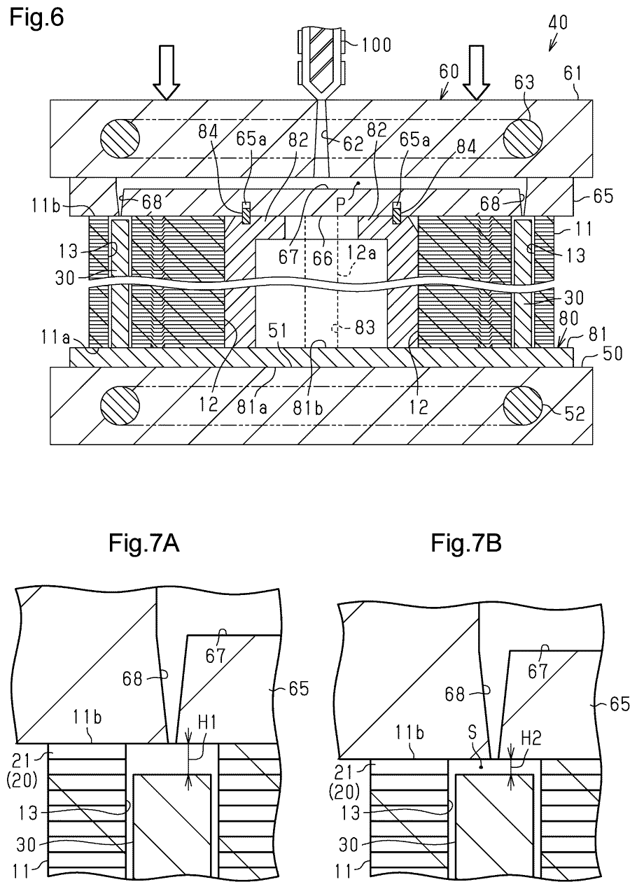

As shown in FIG. 6, in the second arranging step, the gate plate 65 is placed on the second end face 11b of the core 11. At this time, the second contacting surface 66 entirely covers the second end face 11b. The gates 68 of the gate plate 65 are each connected to the opposing one of the magnet housing holes 13 of the core 11. Each gate 68 is, for example, disposed at a position facing the upper surface of the corresponding magnet 30.

### Die Clamping Step

In the die clamping step, the first die 50 and the second die 60 are clamped.

During the die clamping, the die body 61 of the second die 60 contacts the gate plate 65 from the side opposite to the core 11. This connects the sprue 62 of the die body 61 to the runners 67 of the gate plate 65. The core 11, in which the magnets 30 are accommodated in the magnet housing holes 13, is held between the first die 50 and the second die 60. The first end face 11a of the core 11 faces the first contacting surface 51 of the first die 50. The support plate 81 is held between the first end face 11a and the first contacting surface 51. The first end face 11a of the core 11 is thus indirectly pressed against the first contacting surface 51 of the first die 50. The second end face 11b of the core 11 contacts the second contacting surface 66 of the second die 60.

Thereafter, as the clamping of the first die 50 and the second die 60 progresses, the second die 60 pushes the second end face 11b of the core 11 so that the first end face 11a of the core 11 is pressed against the first die 50 with the support plate 81 in between, as indicated by the blank arrows in FIG. 6. In this manner, the die body 61 presses the second end face 11b of the core 11 with the gate plate 65 in between in the present embodiment.

In the core 11, in which the iron core pieces 20 are stacked in a state in which the tabs 21a are press-fitted to each other, a slight gap may be created between each adjacent pair of the iron core pieces 20. In the die clamping step, when the second end face 11b of the core 11 in this state is pressed by the second die 60, the iron core pieces 20 are brought into close contact with each other such that the gaps between the iron core pieces 20 are eliminated. This reduces the stacking height of the core 11.

As shown in FIGS. 7A and 7B, as the stacking height of the core 11 decreases, the distance in the stacking direction from the second end face 11b of the rotor core 11 to the upper surface of each magnet 30 is reduced from a distance H1 to a distance H2. That is, in the die clamping step, the stacking height of the core 11 is reduced by pressing the second end face 11b with the second die 60. A flow space S, through which the plastic 31 flows, is created between the gate plate 65 and the magnet 30 in the stacking direction. The plastic 31 discharged from each gate 68 is introduced into the magnet housing hole 13 through the flow space S.

If the pressing force applied by the second die 60 is relatively small in the die clamping step, the plastic 31 may leak from the magnet housing holes 13 through gaps between the iron core pieces 20 during injection of the plastic 31 into the magnet housing holes 13 in the subsequent injection step. If the pressing force applied by the second die 60 is relatively large, the springback of each iron core piece 20 may increase the stacking height of the core 11 when the pressing force stops being applied after the plastic 31 filling the magnet housing holes 13 hardens. At this time, gaps are created between the iron core pieces 20 due to the springback. Taking these factors into consideration, the present embodiment sets the pressing force applied by the second die 60 in the die clamping step to a magnitude that prevents the plastic 31 from leaking out of the magnet housing holes 13 and prevents gaps from being created between the iron core pieces 20 due to the springback.

### Heating Step

In the heating step, the first die 50 is heated by energizing the first heater 52, and the die body 61 of the second die 60 is heated by energizing the second heater 63. The heating by the first heater 52 and the second heater 63 is performed in a manner that allows the temperature of the plastic 31 filling the magnet housing holes 13 to be lower than the melting point of the plastic 31 and to be maintained at or above the glass transition point of the plastic 31. The heating temperature of the first die 50 and the heating temperature of the die body 61 are set to, for example, be higher than or equal to the glass transition point of the plastic 31 and below the melting point of the plastic 31. For example, the heating temperature of the first die 50 and the heating temperature of the die body 61 are set to be the same temperature. The heat of the first die 50 is transferred to the core 11 through the support plate 81. The heat of the die body 61 is transferred to the core 11 through the gate plate 65. Accordingly, in order to maintain the temperature of the plastic 31 at or above the glass transition temperature, the heating temperature of the first die 50 and the heating temperature of the die body 61 are preferably set to be higher than the glass transition point.

### Injection Step

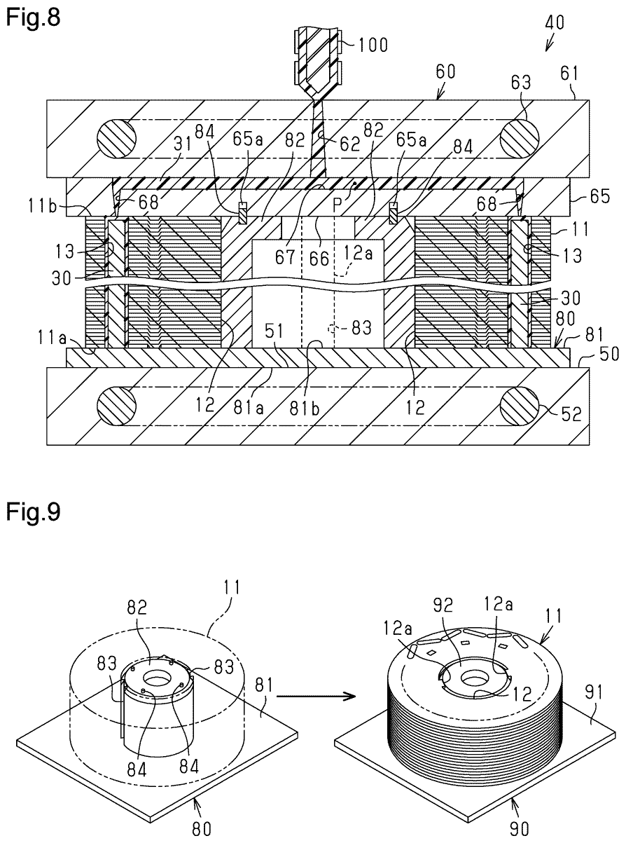

As shown in FIG. 8, in the injection step, the injection device 100 injects the plastic 31 into each magnet housing hole 13 via a passage P in the second die 60. Specifically, the plastic 31 injected from the injection device 100 is injected into the magnet housing holes 13 via the sprue 62, the runners 67, and the gates 68. This fills the magnet housing holes 13 with the plastic 31.

In the injection step, the plastic 31 is injected in a state in which the pressing of the second die 60 in the die clamping step is continued. That is, in the injection step, the plastic 31 is injected in a state in which the first end face 11a of the core 11 is pressed against the first contacting surface 51 of the first die 50. Also, in the injection step, the plastic 31 is injected in a state in which the heating of the first die 50 and the die body 61 is continued in the heating step.

### Cooling Step

In the cooling step, the manufacturing apparatus 40 is left idle for a specified time after the injection of the plastic 31 in the injection step is stopped. At this time, the core 11 is air-cooled. This cools the plastic 31 filling the magnet housing holes 13.

The above-described specified time is set to a time required for the temperature of the plastic 31 filling the magnet housing holes 13 to decrease to a desired temperature (more specifically, a specified temperature that is higher than or equal to the glass transition point and lower than the melting point) after the injection of the plastic 31 in the injection step is stopped. In the present embodiment, based on various experiments and simulations performed by the inventors, time that satisfies such requirements is obtained in advance, and the obtained time is used as the specified time.

In the cooling step, the state in which the second die 60 is pressed in the die clamping step, that is, the state in which the first end face 11a of the core 11 is pressed against the first contacting surface 51 of the first die 50 is maintained. In the cooling step, the heated state of the first die 50 and the die body 61, which has been achieved in the heating step, is maintained.

### Removal Step

In the removal step, the first die 50 and the second die 60 are opened. From the space between the first die 50 and the second die 60, the core 11, the magnets 30, and the plastic 31 are removed while being supported by the support member 80.

The core 11, the magnets 30, the plastic 31, and the support member 80 are removed at a point in time when the cooling step is completed, more specifically, at a point in time when the specified time has elapsed. Accordingly, in the removal step, the core 11 and the magnets 30 are removed from the space between the first die 50 and the second die 60 when the temperature of the plastic 31 injected into the magnet housing holes 13 is higher than or equal to the glass transition point and lower than the melting point. At this time, the plastic 31 filling the magnet housing holes 13 is in a state similar to soft rubber.

### Correction Step

As shown in FIG. 9, in the correction step, the core 11, in which the magnets 30 and the plastic 31 are provided, is detached from the support member 80. The detached core 11 is then attached to a correction jig 90 for shape correction.

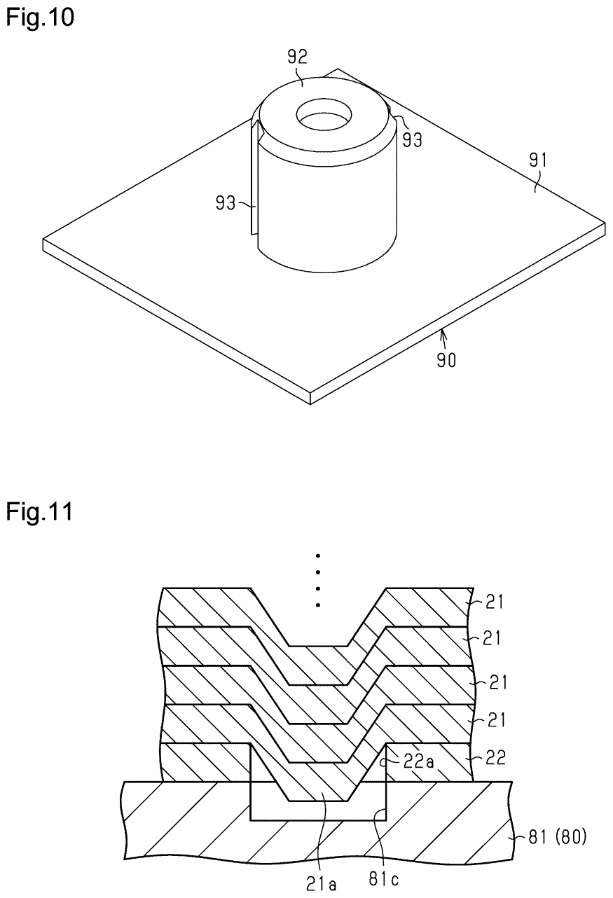

FIG. 10 shows the correction jig 90. As shown in FIG. 10, the basic structure of the correction jig 90 is identical to the support member 80. The correction jig 90 includes a substantially rectangular support plate 91 and a cylindrical post portion 92 protruding from a center portion in plan view of the support plate 91. The post portion 92 extends in the thickness direction of the support plate 91. When attaching the core 11 to the correction jig 90, the post portion 92 of the correction jig 90 is inserted into the center hole 12 of the core 11. The post portion 92 includes two engagement grooves 93 in the outer circumferential surface. Each engagement groove 93 extends in the axial direction of the post portion 92. The engagement grooves 93 each have a shape that corresponds to the keys 12a of the core 11. When attaching the core 11 to the correction jig 90, the keys 12a of the core 11 are fitted into the engagement grooves 93 of the correction jig 90.

The shape of the correction jig 90 differs from the shape of the support member 80 in the following points. The difference between the cross-sectional shape of the post portion 92 of the correction jig 90 and the cross-sectional shape of the center hole 12 of the core 11 is smaller than the difference between the cross-sectional shape of the post portion 82 of the support member 80 and the cross-sectional shape of the center hole 12 of the core 11. Specifically, the outer diameter of the post portion 92 of the correction jig 90 is greater than the outer diameter of the post portion 82 of the support member 80. Further, the width of the engagement grooves 93 of the correction jig 90 is smaller than the width of the engagement grooves 83 of the support member 80.

In the correction step, the shape of the rotor 10 is corrected by attaching the rotor 10 to the correction jig 90. Specifically, any positional misalignment in the radial direction of each iron core piece 20, which forms the core 11, is corrected by fitting the post portion 92 of the correction jig 90, which has a larger outer diameter than the post portion 82 of the support member 80, into the center hole 12 of the core 11. Also, any positional misalignment in the circumferential direction of each iron core piece 20, which forms the core 11, is corrected by fitting the keys 12a of the core 11 into the engagement grooves 93 of the correction jig 90, which have narrower widths than the engagement grooves 83 of the support member 80. Such correction of the shape of the rotor 10 by the correction jig 90 is implemented since the plastic 31 filling the magnet housing holes 13 is in a state similar to soft rubber.

### Hardening Step

In the hardening step, for example, the core 11 is left idle in a state of being attached to the correction jig 90 for a specified time so that the core 11 is air-cooled. This hardens the plastic 31 filling the magnet housing holes 13. The rotor 10 is manufactured in this manner.

Finally, the rotor 10 is removed from the correction jig 90.

### Operation and Advantages

Operation and advantages of the method for manufacturing the rotor 10 according to the present embodiment will now be described.

(1) In the die clamping step, the first die 50 and the second die 60 are clamped so as to hold the core 11 between the first die 50 and the second die 60 in a state in which the magnets 30 are accommodated in the magnet housing holes 13. Then, in the injection step, the plastic 31 is injected into the magnet housing holes 13. Thereafter, in the removal step, the first die 50 and the second die 60 are opened, and the core 11 and the magnets 30 are removed from the space between the first die 50 and the second die 60. In the removal step, the core 11 and the magnets 30 are removed when the temperature of the plastic 31 injected into the magnet housing holes 13 is higher than or equal to the glass transition point and lower than the melting point.

When the temperature of the plastic 31, which is thermoplastic, is higher than or equal to the glass transition point and lower than the melting point, the plastic 31 is in a state between liquid and hard glass, more specifically, is in a state similar to soft rubber. At this time, the plastic 31 injected into the magnet housing holes 13 is not yet in a hard-glass state, but is in a soft-rubber state, that is, in a state of remaining inside the magnet housing holes 13 without flowing out from the magnet housing hole 13.

With the above-described method, the rotor 10 can be removed from the space between the first die 50 and the second die 60 at a point in time when the temperature of the plastic 31 becomes a specified temperature that is higher than or equal to the glass transition point and lower than the melting point. Thus, the rotor 10 can removed without allowing the plastic 31 to flow out from the magnet housing holes 13 at an earlier time than in a case in which the rotor 10 is removed when the plastic 31 in the magnet housing holes 13 is sufficiently hardened. Thus, even if the temperature of the plastic 31 injected into the magnet housing holes 13 is not lowered in the injection step, it is possible to shorten the time during which the plastic 31 filling the magnet housing holes 13 is cooled between the first die 50 and the second die 60. This reduces the cycle time of the injection molding and thus improves the productivity of the manufacture of the rotor 10.

(2) In the correction step after the removal step, the core 11 is attached to the correction jig 90 for shape correction.

According to the above-described method, by utilizing the characteristics of the plastic (thermoplastic) 31, which is in a soft-rubber state when the temperature is higher than or equal to the glass transition point and lower than the melting point, the manufacturing of the rotor 10 can be executed as follows. In the injection step, the plastic 31 can be injected into the magnet housing holes 13 while allowing for a certain degree of shape error in the core 11. In the subsequent correction step, the core 11 is attached to the correction jig 90 in order to correct the shape of the core 11 to a shape with a small error.

(3) In the die clamping step, the first die 50 and the second die 60 are clamped such that the first end face 11a of the core 11 faces the first die 50 and the second end face 11b of the core 11 contacts the second die 60. Thereafter, in the injection step, the plastic 31 is injected into the magnet housing holes 13 via the passage P, which is formed in the second die assembly 60 to be connected to the magnet housing holes 13, in a state in which the first die 50 is heated.

In the injection step of the above-described method, the magnet housing holes 13 are filled with the plastic 31, which is thermoplastic, via the passage P in the second die 60, which contacts the second end face 11b of the rotor core 11. The temperature of the injected plastic 31 decreases as it travels from the second end face 11b toward the first end face 11a inside each magnet housing hole 13. In the injection step, the plastic 31 is injected into the magnet housing holes 13 in a state in which the first die 50, which is located close to the first end face 11a of the core 11, is heating the core 11 through the support plate 91. Accordingly, the temperature of the plastic 31 is unlikely to decrease when the plastic 31 travels toward the first end face 11a from the second end face 11b in each magnet housing hole 13. This limits an increase in the viscosity of the plastic 31. This limits an increase in the injection pressure of the plastic 31. Further, the temperature of the plastic 31 injected into the magnet housing holes 13 is prevented from falling below the glass transition point.

(4) In the die clamping step, the second die 60 presses the second end face 11b of the core 11 to press the first end face 11a of the core 11 against the first die 50 with the support plate 81 in between. In this manner, the first die 50 and the second die 60 are clamped.

With the above-described method, the first end face 11a of the core 11 is pressed against the first die 50 with the support plate 81 in between, so that the contact area between the first end face 11a and the support plate 81 increases. Also, the air layer between the first end face 11a and the support plate 81 is reduced. As a result, the temperature of the heated first die 50 is easily transferred to the core 11 via the support plate 81, so that the core 11 is heated at an early stage. This improves the productivity of the manufacture of the rotor 10.

(5) In the die clamping step, the second end face 11b is pressed such that the iron core pieces 20 are brought into close contact with each other in the stacking direction to reduce the stacking height of the core 11, and that the flow space S is created between the second die 60 and each magnet 30 in the stacking direction.

If gaps exist between adjacent iron core pieces 20 in the stacking direction, the plastic 31 may leak from the gaps in the injection step. In this case, the injection step may be performed with the core 11 pressed in order to eliminate the gaps between the iron core pieces 20. However, if the core 11 is pressed to excessively reduce the stacking height of the core 11, the second die 60 may contact the end faces of the magnets 30 accommodated in the magnet housing holes 13. In this case, since the passage P of the second die 60 is closed by the end faces of the magnets 30, the magnet housing holed 13 may fail to be filled with the plastic 31. Leakage of the plastic 31 from gaps between the iron core pieces 20 is particularly noticeable in the case of thermoplastic in which the injection pressure is more likely to be higher than in the case of a thermosetting plastic.

In this regard, in the above-described method, the iron core pieces 20 are brought into close contact with each other by pressing the core 11. This reduces the stacking height of the core 11, but ensures the flow space S between the second die 60 and each magnet 30. This allows the plastic 31 to fill the magnet housing holes 13, while preventing the plastic 31 from leaking from gaps between the iron core pieces 20.

(6) In the injection step, the plastic 31 is injected into the magnet housing holes 13 in a state in which the second die 60 is heated.

With the above-described method, the heating of the second die 60 limits a decrease in the temperature of the plastic 31 when the plastic 31 passes through the passage P. Thus, the temperature of the plastic 31 is unlikely to decrease before the plastic 31 reaches the magnet housing holes 13. This limits an increase in the injection pressure of the plastic 31.

(7) In the die clamping step, the first die 50 and the second die 60 are clamped in a state in which the support plate 81, which supports the core 11 and the magnets 30, is held between the first die 50 and the first end face 11a of the core 11.

With the above-described method, the support plate 81, which supports the core 11 and the magnets 30, is moved to the space between the first die 50 and the second die 60 in an opened state, so that the core 11 and the magnets 30 are conveyed to the space between the first die 50 and the second die 60. Also, by moving the support plate 81, which supports the core 11 and the magnets 30, from the space between the first die 50 and the second die 60, the core 11 and the magnets 30 are conveyed from the space between the first die 50 and the second die 60. This allows the core 11 and the magnets 30 to be readily conveyed to and from the space between the first die 50 and the second die 60 using the support plate 81.

(8) The second iron core piece 22 is located at an end of the core 11 in the stacking direction. When the tabs 21a of the first iron core piece 21 protrude from the through-holes 22a of the second iron core piece 22, the protruding ends of the tabs 21a contact the support plate 81 when the first die 50 and the second die 60 are clamped. As a result, a gap may be created between the core 11 and the support plate 81. In a case in which the core 11 is inverted from the state shown in FIG. 5 and is supported on the support plate 81, the protruding ends of the tabs 21a contact the gate plate 65 when the first die 50 and the second die 60 are clamped. This may create gaps between the core 11 and the gate plate 65. In this case, the plastic 31 injected into the magnet housing holes 13 of the core 11 in the injection step leaks through the gaps. However, since the protruding ends of the tabs 21a are crushed such that the protruding ends are located inside the through-holes 22a in the crushing step before the injection step, such gaps are not created. Thus, the plastic 31 injected into the magnet housing holes 13 of the core 11 in the injection step is prevented from leaking through such gaps. Also, when gaps are created between the core 11 and the support plate 81, the contact area between the core 11 and the support plate 81 is reduced, so that the heat of the first die 50 is not readily transferred to the core 11 through the support plate 81. Such a drawback is prevented.

### Modifications

The above-described embodiment may be modified as follows. The above-described embodiment and the following modifications can be combined as long as the combined modifications remain technically consistent with each other.

As shown in FIG. 11, the support plate 81 may include accommodating recesses 81c in a first end face 81a, which is an end face facing the core 11. The accommodating recesses 81c respectively accommodate the protruding ends of the tabs 21a, which protrude from the through-holes 22a, which open in the first end face 11a of the core 11. In this case, in the injection step, the plastic 31 is injected into the magnet housing holes 13 with the protruding ends of the tabs 21a protruding from the through-holes 22a accommodated in the accommodating recesses 81c. With this method, when the support plate 81 contacts the first end face 11a of the core 11, the protruding ends of the tabs 21a are accommodated in the accommodating recesses 81c. Accordingly, as compared to a case in which the support plate 81 does not have the accommodating recesses 81c, the contact area between the support plate 81 and the first end face 11a is increased. As a result, the temperature of the heated first die 50 is readily transferred to the core 11 via the support plate 81. This shortens the time required to raise the temperature of the core 11 to a desired temperature. Also, this modification omits the crushing step in the above-described embodiment.

The core 11 may be formed by stacking multiple core piece blocks, which are each formed by stacking multiple first iron core pieces 21 and one second iron core piece 22. In this case, the core piece blocks are fixed to each other with, for example, the plastic 31.

The first iron core pieces 20 do not necessarily need to be joined to each other by press-fitting the tabs 21a to each other. The iron core pieces 20 may be joined to each other by, for example, the plastic 31

In the die clamping step, the flow space S does not necessarily need to be created between the second die 60 and each magnet 30. In this case, each gate 68 is preferably set at a position that is not aligned with the magnet 30 in a range of the corresponding magnet housing hole 13, that is, at a position that does not face the magnet 30.

In the die clamping step, the second end face 11b of the core 11 does not necessarily need to be pressed by the second die 60.

The heating temperature of the first die 50 may be higher than the heating temperature of the second die 60. In this case, since the temperature gradient in the stacking direction of the magnet housing holes 13 decreases, the temperature of the plastic 31 injected into the magnet housing holes 13 is unlikely to decrease.

In the heating step, the die body 61 does not necessarily need to be heated. In this case, since the gate plate 65 is not heated, the plastic 31 remaining in the passage P hardens at an early stage. This allows the gate plate 65 to be separated from the rotor 10 at an early stage after the hardening step.

In the injection step, the plastic 31 may be injected immediately after the energization of the first heater 52 and the second heater 63 is stopped. That is, if the core 11 is sufficiently heated immediately before the plastic 31 is injected, the energization of the first heater 52 and the second heater 63 may be stopped before the plastic 31 is injected.

The core 11 may be preheated prior to the injection step.

In the heating step, the first die 50 does not necessarily need to be heated. In other words, it suffices if the core 11 can be removed from the space between the first die 50 and the second die 60 when the temperature of the plastic 31 injected into the magnet housing holes 13 is higher than or equal to the glass transition point and lower than the melting point.

The manufacturing apparatus 40 may include a movable first die 50 and a fixed second die 60. In this case, the die clamping is performed by bringing the first die 50 close to the core 11 mounted on the second die 60.

The gate plate 65 may be coupled to the die body 61 to be movable toward and away from the die body 61.

The gate plate 65 may be omitted from the second die 60. In this case, it suffices if a flow passage P that corresponds to the runners 67 and the gates 68 is formed in the second die 60.

The correction step may be omitted. In this case, a support member 80 having the same shape as the correction jig 90 is used to manufacture the rotor 10 with a high accuracy.

The support member 80 may be omitted. In this case, it suffices if the first die 50 and the second die 60 are clamped with the core 11 in between such that the first end face 11a of the core 11 contacts the first contacting surface 51 of the first die 50, and the second end face 11b of the core 11 contacts the second contacting surface 66 of the second die 60. The first end face 11a of the core 11 is thus directly pressed against the first contacting surface 51 of the first die 50.

The plastic 31 is not limited to a liquid crystal polymer and may be, for example, polyphenylene sulfide (PPS), polyetherether ketone (PEEK), or polyamide (PA) such as nylon 66.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rotor, the rotor including a core that includes a magnet housing hole and a magnet that is accommodated in the magnet housing hole and fixed to the core with a thermoplastic, the core having a first end face and a second end face, which is located on a side opposite to the first end face, the magnet housing hole opening in the first end face and the second end face, the method comprising:
clamping a first die and a second die so as to hold the core between the first die and the second die in a state in which the magnet is accommodated in the magnet housing hole;
injecting the thermoplastic into the magnet housing hole after the die clamping; and
after injecting the thermoplastic, opening the first die and the second die and removing the core and the magnet from a space between the first die and the second die,
wherein the removing the core and the magnet includes removing the core and the magnet from the space between the first die and the second die when a temperature of the thermoplastic injected into the magnet housing hole is higher than or equal to a glass transition point and lower than a melting point.

2. The manufacturing method according to claim 1, further comprising, after removal of the core and the magnet, attaching the core to a correction jig for shape correction.

3. The manufacturing method according to claim 1, wherein
the die clamping includes clamping the first die and the second die such that the first end face faces the first die and the second end face contacts the second die, and the injecting the thermoplastic includes injecting, in a state in which the first die is heated, the thermoplastic into the magnet housing hole through a passage that is provided in the second die to be connected to the magnet housing hole.

4. The manufacturing method according to claim 3, wherein
the core includes stacked iron core pieces,
the die clamping includes pressing the second end face with the second die, thereby directly or indirectly pressing the first end face against the first die.

5. The manufacturing method according to claim 4, wherein
the core has a stacking height, the stacking height being a dimension from the first end face to the second end face,
a length of the magnet in a stacking direction of the iron core pieces is shorter than the stacking height, and
the die clamping includes pressing the second end face such that a gap is created between the second die and the magnet in the stacking direction, while reducing the stacking height by causing the iron core pieces to closely contact each other in the stacking direction.

6. The manufacturing method according to claim 1, wherein
the die clamping includes clamping the first die and the second die such that the first end face faces the first die and the second end face contacts the second die, and
the injecting the thermoplastic includes injecting, in a state in which the second die is heated, the thermoplastic into the magnet housing hole through a passage that is provided in the second die to be connected to the magnet housing hole.

7. The manufacturing method according to claim 1, wherein the die clamping includes clamping the first die and the second die in a state in which a support plate supporting the core and the magnet is held between the first die and the first end face of the core.

8. The manufacturing method according to claim 7, wherein
the core includes stacked iron core pieces,
the iron core pieces include:
first iron core pieces that include tabs that bulge on one side in the stacking direction of the iron core pieces, the first iron core pieces being stacked with the tabs being joined to each other; and
a second iron core piece including a through-hole into which the tab of the first iron core piece adjacent to the second iron core piece in the stacking direction is inserted, the second iron core piece forming the first end face, and
the die clamping includes clamping the first die and the second die in a state in which a protruding end of the tab protruding from the through-hole is accommodated in an accommodating recess formed in the support plate.

9. The manufacturing method according to claim 1, wherein
the core includes stacked iron core pieces,
the iron core pieces include:
first iron core pieces that include tabs that bulge on one side in the stacking direction of the iron core pieces, the first iron core pieces being stacked with the tabs being joined to each other; and
a second iron core piece including a through-hole into which the tab of the first iron core piece adjacent to the second iron core piece in the stacking direction is inserted, the second iron core piece forming the first end face or the second end face, and
the method further comprises, prior to the die clamping, pressing a protruding end of the tab protruding from the through-hole, thereby crushing the protruding end such that the protruding end is located inside the through-hole.
